(19) United States
(12) Patent Application Publication
(10) Pub. No.: US 2016/0259882 A1
(43) Pub. Date: Sep. 8, 2016

(54) METHOD AND SYSTEM FOR ESTIMATING GENOMIC HEALTH

(71) Applicant: MEDISAPIENS OY, Helsinki (FI)

(72) Inventors: Kalle OJALA, Helsinki (FI); Sami KILPINEN, Helsinki (FI)

(21) Appl. No.: 15/034,459

(22) PCT Filed: Nov. 4, 2015
(86) PCT No.: PCT/FI2014/050828

§ 371 Date: May 4, 2016

(30) Foreign Application Priority Data
Nov. 4, 2013 (FI) 20136079

(51) Int. Cl. G06F 19/18

(52) U.S. Cl. CPC G06F 19/18

(57) ABSTRACT

Techniques for estimating genomic health of a sexually reproducing organism. Stored information on hereditary diseases is used to determine a risk for each disease for allele combinations in a specimen, and to determine a degree of severity, wherein the risk and severity are commensurate. For each hereditary disease a risk is determined for the specimen to have the disease from the from the specimen's genotype; a default risk is assigned, if the hereditary disease exhibits Mendelian inheritance and if the specimen is a carrier of the disease. The risk for the hereditary disease is multiplied by an expansive function (e.g., square) of the severity. A statistically representative value of the multiplied risks is calculated, replacing zero values with marginal finite values if the expansive function cannot process zero values.

### PRIORITY CLAIM

This patent application is a U.S. National Phase of International Patent Application No. PCT/FI2014/050828, filed 4 Nov. 2014, which claims priority to Finnish Patent Application No. 20136079, filed 4 Nov. 2013 the disclosure of which are incorporated herein by reference in their entirety.

### FIELD

The disclosed embodiment relates to microbiological techniques for estimating genomic health of a sexually reproducing organism, such as an animal or plant. Genomic health thus estimated finds multiple uses in various fields, including breeding. While the following description uses the term “animal”, it should be remembered that the technique is applicable to sexually reproducing plants. In implementations wherein breeding is involved, “organism” or “animal” shall exclude humans in jurisdictions that so require.

### BACKGROUND

Breeders of animals or plants face the problem that the genomic health of a specimen cannot be assessed until some time, typically several years, after birth. This time is a significant investment for breeders. Accordingly, there is a need for improved techniques for estimating genomic health of a specimen of a sexually reproducing organism.

### SUMMARY

It is an object of the disclosed embodiments to alleviate one or more of the problems identified above. Specifically, it is an object of the disclosed embodiments to provide methods, equipment and computer program products that provide improvements with regard to one or more of: accuracy, speed, completeness, comprehensibility, applicability to a diversity of organisms, and so on.

### BRIEF DESCRIPTION OF THE DRAWINGS

In the following section, specific embodiments of the disclosed embodiments will be described in greater detail in connection with illustrative but non-restrictive examples. A reference is made to the following drawings:

FIG. 1 shows an embodiment of an information processing architecture for carrying out the various data processing tasks;

FIG. 2 is a flow chart that illustrates calculation of the disease-induced part of the GHI;

FIG. 3 is a flow chart that illustrates how degree of heterozygosity is taken into account in the calculation of overall GHI;

FIG. 4 is flow chart that illustrates prediction of the GHI for descendants of pair of male and female animals known by the data processing system;

FIG. 5 shows a distribution of a disease-induced part of the GHI for a number of dogs which were known by the data processing system;

FIG. 6 shows the distribution of the degree of heterozygosity for the dogs discussed in connection with FIG. 5; and

FIG. 7 shows a distribution of a combined GHI, which is a combination of the disease-induced part and the degree of heterozygosity.

### DETAILED DESCRIPTION OF SOME SPECIFIC EMBODIMENTS

An object of the disclosed embodiments, to provide methods, equipment and computer program products that provide improvements with regard to one or more of: accuracy, speed, completeness, comprehensibility, applicability to a diversity of organisms, may be attained with methods, equipment and computer program products as defined in the attached independent claims. The following description with the associated drawings, as well as the dependent claims, relate to specific embodiments and implementations which solve additional problems and/or provide additional benefits.

The disclosed embodiments provide a method for estimating overall genomic health of a sexually reproducing organism or its virtual presentation, wherein said estimating comprises:

in a set-up phase:
storing information on a plurality of hereditary diseases potentially affecting a species of a sexually reproducing organism;
for each hereditary disease in the plurality of hereditary diseases:

determining a risk for that disease for a plurality of allele combinations in a specimen of the species;

determining a degree of severity in the species;

wherein the risk and severity are commensurate;

in a specimen-specific phase:
for each hereditary disease:

determining a risk for the specimen to have the hereditary disease from the from the specimen's genotype;

assigning a default risk which is between 0.2 and 0.8 of the range of values for the risk, if the hereditary disease exhibits Mendelian inheritance and if the specimen is a carrier of the disease;

multiplying the risk for the hereditary disease by an expansive function of the severity; and

calculating a statistically representative value of the multiplied risks.

In the following, the statistically representative value of the multiplied risks, which may be an average, mean, percentile, or the like value of the multiplied risks, is called a Genomic Health Index (“GHI”) in the following.

Another aspect is a data processing system specifically adapted to calculate the index. Yet another aspect is a computer program product whose execution in a computer system causes the computer system to carry out the inventive method.

The inventive index GHI is thus based on the idea that it is desirable to calculate a single index or number that describes overall health of the genotype of an animal. The GHI index is based on the animal's breed disease heritage and heterozygosity. The GHI index is may scale (normalize) in such a manner that an animal with a mean value for heterozygosity, and free from hereditary diseases, obtains a value of 100 points. Hereditary diseases lower the value of GHI, as far as zero in extreme cases, wherein the animal has a significantly above-average number of hereditary diseases.

The majority of animals obtains a value between 80 and 100, depending on the breed disease heritage. The specific heterozygosity of the animal may alter this value by up to ±20 points. The healthier the animal, the higher is the GHI. Conversely, hereditary diseases and abnormally high degree of homozygosity lower the GHI.

The GHI can be calculated as follows. For each hereditary disease, the risk for that disease (probability of occurrence) has been determined for each possible allele combination. The probability of occurrence indicates the risk for the combination of hereditary disease and allele combination. In addition, a degree of severity has also been determined for each hereditary disease. The degree of severity may be normalized to a scale of 0-1, for example. For Mendelian diseases, ie, diseases with Mendelian-type inheritance, a carrier of a disease is assigned a risk of 0.5 (assuming the normalized scale), wherein the aim is to describe the health of the animal's genotype, if not phenotype.

The disease-induced part of the GHI can be calculated as follows. For each known hereditary disease, the probability for an animal to have this disease is determined from the animal's genotype. The probability for the animal to have this disease is multiplied by a function of the above-mentioned degree of severity, wherein the function of the degree of severity emphasizes severe diseases with compared with less severe diseases. An illustrative example of such a function is the square (second power) of the degree of severity. A statistically representative value, such as average, mean or the like, of the probabilities is calculated. In cases where the result for an animal is zero, the result is set to a value marginally higher than zero, such as 0.001, to avoid zeros in later processing phases. The value marginally higher than zero, such as 0.001, is lower than the lowest possible value derived from hereditary values.

The statistically representative value, such as average, is plotted on a scale which compresses broad value ranges, such as on a logarithmic scale. To produce an index which is easily comprehensible for humans, the values for multiple animals may be scaled in such a manner that a perfectly healthy animal (with respect to hereditary diseases) obtains a value of 1, 10, or 100, which are commonly used as a base value for various indices. The animal with the highest burden of hereditary diseases, such as an average or mean of probability for a disease multiplied by square of severity obtains a value of 0.2-0.8, preferably 0.4-0.6 and optimally about 0.50-0.55. As regards such scaling, computers can process numbers regardless of size or scale but the scaling facilitates comprehending and comparing the indices for humans.

In an illustrative but non-restrictive implementation, the disease-induced part of the GHI for an individual animal can be calculated as follows:

$${GHI}_{dis} = {f}_{comp} ( {\sum }_{i = 1}^{D} \frac{{risk}_{i} \cdot {f}_{exp} ( {severity}_{i} )}{{Num}_{dis}} )$$

Herein:

GHI_{dis}=part of GHI that is caused by hereditary diseases

f_{comp}=compressive function, such as logₙ, eg log₂; function f is compressive if: (A>B)→f(A)/f(B)<A/B

i=running index for an individual hereditary disease

D=total number of hereditary diseases known by the calculation process

Num_{dis}=number of hereditary diseases for which risk/severity data is known

riskᵢ=risk (probability) for the animal to have disease i, as determined by the animal's allele combination; for Mendelian diseases the carrier of the disease is assigned a risk value of 0.5

severityᵢ=severity of disease i

fexp=expansive function, ie, function that emphasizes large values compared with small values, eg square of value; function f is expansive if: (A>B) →f(A)/f(B)>A/B

=multiplication operator, or any operator or function whose output has better than 0.5 correlation with the output of multiplication operator in the expected operating range.

Assuming that log2 is used as the compressive function and square (2nd power) as the expansive function, the above formula can be rewritten as:

$${GHI}_{dis} = {log}_{2} ( {\sum }_{i = 1}^{D} \frac{{risk}_{i} \cdot {severity}_{i}^{2}}{{Num}_{dis}} )$$

In addition to the disease-induced part GHIdis, a degree of heterozygosity Deghz is calculated in some implementations. In an illustrative but non-restrictive implementation, the degree of heterozygosity Deghz may be calculated as a simple portion of the animal's loci that are heterozygous. To make the Deghz portion commensurate with the above-described disease-induced part GHIdis, the degree of heterozygosity Deghz is scaled in such a manner that a statistically representative value, such as mean, for all known animals is 100 and that a majority of the animals reside in the range of 80-120. The portions are normally distributed without additional processing.

Finally, an overall GHI value is calculated as a combination of GHIdis and

Deghz in such a manner that the GHIdis is adjusted up or down, depending on how much and in which direction the Deghz deviates from its base value (eg mean), which in the present example is 100. An illustrative but non-restrictive calculation formula can be written as:

GHI=GHI_{dis}+Deg_{hz}−100

An advanced embodiment relates to breeding and comprises prediction of the GHI for descendants of pair of parents (male and female specimens) known by the data processing system. Implementations that include breeding are restricted to non-human animals. The present embodiment is based on a simulation of a number of virtual descendants of the parents, examination of the genotypes of the virtual descendants and determine the genomic health index for a representative real descendant.

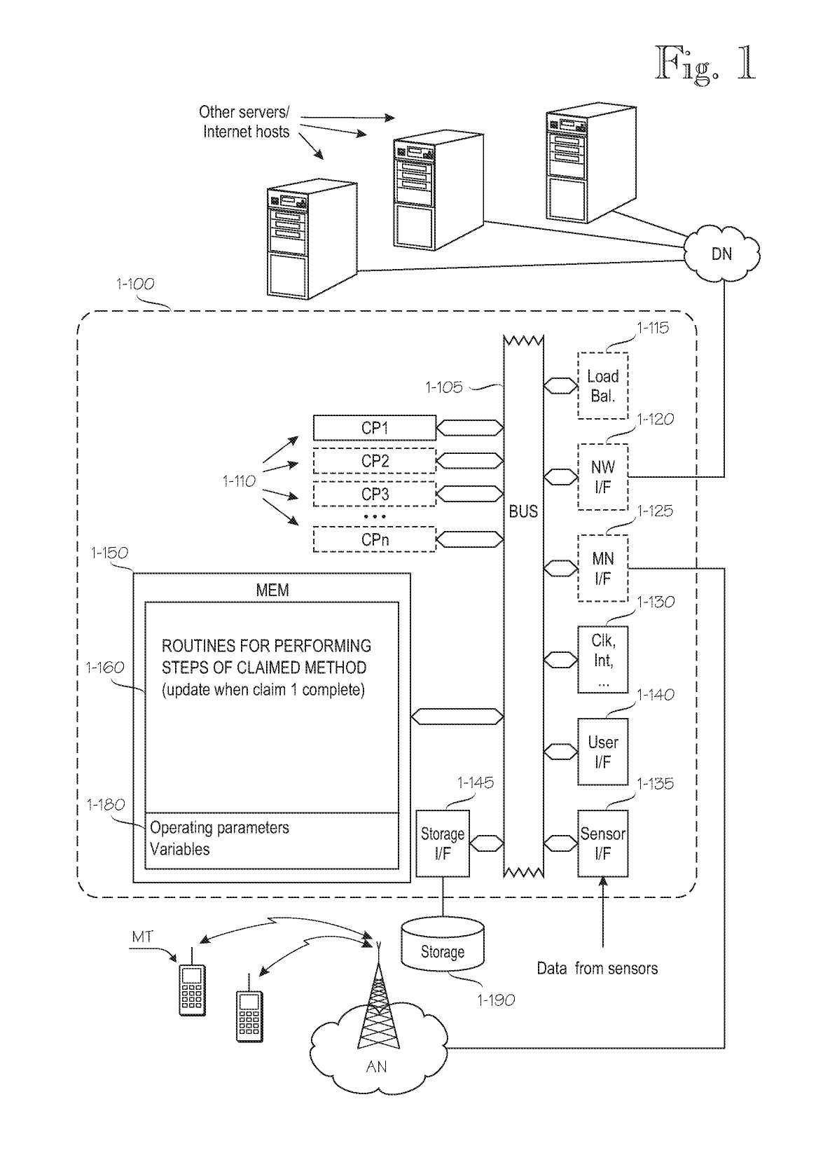

FIG. 1 shows an exemplary data processing architecture that specifically adapted to perform the various data processing tasks relating to embodiments. For the interest of brevity, the data processing architecture will be referred to as a computer, but those skilled in the art will realize that the data processing architecture need not be implemented as a dedicated or compact computer. Instead, several alternative or complementary techniques are possible, such as distributed or embedded implementations, as are techniques in which the inventive functionality is installed on a data processing system that exists for other purposes.

The architecture of the computer, generally denoted by reference numeral 1-100, comprises one or more central processing units CP1 . . . CPn, generally denoted by reference numeral 1-110. Embodiments comprising multiple processing units 1-110 may provide with a load balancing unit 1-115 that balances processing load among the multiple processing units 1-110. The multiple processing units 1-110 may be implemented as separate processor components or as physical processor cores or virtual processors within a single component case. In a typical implementation the computer architecture 1-100 comprises a network interface 1-120 for communicating with various data networks, which are generally denoted by reference sign DN. The data networks DN may include local-area networks, such as an Ethernet network, and/or wide-area networks, such as the internet. In some implementations the computer architecture may comprise a wireless network interface, generally denoted by reference numeral 1-125. By means of the wireless network interface, the computer 1-100 may communicate with various access networks AN, such as cellular networks or Wireless Local-Area Networks (WLAN). Other forms of wireless communications include short-range wireless techniques, such as Bluetooth and various “Bee” interfaces, such as XBee, ZigBee or one of their proprietary implementations.

The computer architecture 1-100 may also comprise a local user interface 1-140. Depending on implementation, the user interface 1-140 may comprise local input-output circuitry for a local user interface, such as a keyboard, mouse and display (not shown).

The computer architecture also comprises memory 1-150 for storing program instructions, operating parameters and variables. Reference numeral 1-160 denotes a program suite for the server computer 1-100.

The computer architecture 1-100 also comprises circuitry for various clocks, interrupts and the like, and these are generally depicted by reference numeral 1-130.

Reference number 1-135 denotes an optional interface by which the computer obtains data from external sensors, analysis equipment or the like. In some embodiments the data processing system is coupled with equipment that determines an organism's genotype from an in-vitro sample obtained from the organism. In other embodiments the genotypes are determined elsewhere and the data processing system may obtain data representative of the genotype via any of its data interfaces.

The computer architecture 1-100 further comprises a storage interface 1-145 to a storage system 1-190. The storage system 1-190 comprises non-volatile storage, such as a magnetically, optically or magneto-optically rewritable disk and/or non-volatile semiconductor memory, commonly referred to as Solid State Drive (SSD) or Flash memory. When the computer is switched off, the storage system 1-190 may store the software that implements the processing functions, and on power-up, the software is read into semiconductor memory 1-150. The storage system 1-190 also retains operating data and variables over power-off periods. The various elements 1-110 through 1-150 intercommunicate via a bus 1-105, which carries address signals, data signals and control signals, as is well known to those skilled in the art.

The inventive techniques may be implemented in the computer architecture 1-100 as follows. The program suite 1-160 comprises program code instructions for instructing the processor or set of processors 1-110 to execute the functions of embodiments, including:

in a set-up phase:
storing information on a plurality of hereditary diseases potentially affecting a species of a sexually reproducing organism;
for each hereditary disease in the plurality of hereditary diseases:

determining a risk for that disease for a plurality of allele combinations in a specimen of the species;

determining a degree of severity in the species;

wherein the risk and severity are commensurate;

in a specimen-specific phase:
for each hereditary disease:

determining a risk for the specimen to have the hereditary disease from the from the specimen's genotype;

assigning a default risk which is between 0.2 and 0.8 of the range of values for the risk, if the hereditary disease exhibits Mendelian inheritance and if the specimen is a carrier of the disease;

multiplying the risk for the hereditary disease by an expansive function of the severity; and

calculating a statistically representative value of the multiplied risks.

In addition to instructions for carrying out a method according to the its embodiments, the memory 1-160 stores instructions for carrying out normal system or operating system functions, such as resource allocation, inter-process communication, or the like.

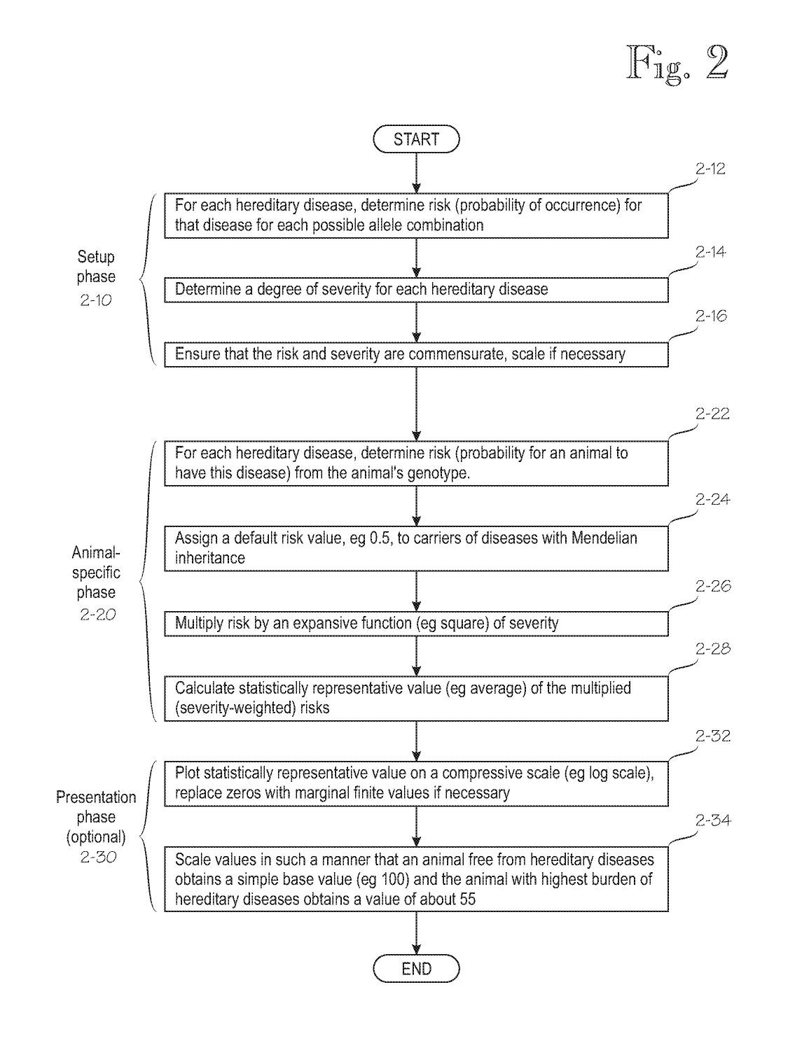

FIG. 2 is a flow chart that illustrates calculation of the disease-induced part of the GHI. The flow chart comprises two major sections. Reference number 2-10 denotes a setup phase which is executed when the data processing system is set up or updated, but not necessarily for each individual animal. The setup phase comprises operations 2-12 through 2-16. Operation 2-12 comprises determining, for each hereditary disease, a risk (probability of occurrence) for that disease for each possible allele combination in a population of animals. Operation 2-14 comprises determining a degree of severity for each hereditary disease. Operation 2-16 comprises ensure that the risk and severity are commensurate, scale if necessary. Operation 2-16 is mentioned for the sake of completeness, and in reality it is a operation that is carried out by the system designer.

Operations 2-22 through 2-34 constitute an animal-specific phase which is executed for each animal for which the GHI is to be calculated. In operation 2-22, for each hereditary disease, the risk (probability for an animal to have this disease) is determined from the animal's genotype. This operation utilizes, in particular, the results of operation 2-12 of the setup phase. In operation 2-24, a default risk value, eg 0.2-0.8, preferably 0.4-0.6 and optimally about 0.5 on a scale 0-1, is assigned to carriers of diseases with Mendelian inheritance. In operation 2-26 the risk obtained at 2-24 is combined (eg multiplied) with an expansive function (eg square) of severity, utilizing results of operation 2-14. As described earlier, an expansive function is one that emphasizes large values in comparison with small values. The idea is that a combination of a high-risk disease and a low-risk disease is considered potentially worse than a combination of two diseases whose risks are averages of the high-risk disease and a low-risk disease. A typical but non-restrictive implementation of such an expansive function is square (2nd power), but other functions can be used, such as powers higher than unity, exponent functions, antilog functions, operation functions, to name just a few examples. In the combination of risk with the expansive function of severity, the “combination” may be implemented by multiplication or any other operation or two-argument function whose output correlates with the output of multiplication with 0.5 or better correlation over the expected operation range. Operation 2-28 comprises calculating a statistically representative value (eg average, mean, percentile) of the multiplied (severity-weighted) risks. Zeros may be replaced with marginal finite values, such as 0.001, to avoid zeros in the following operation if that operation can't process zero values.

At this point, the data processing system has combined the severity-weighted risks for each known hereditary disease into a statistically representative value. This statistically representative value can be used as a simple implementation of the genomic health index. A number of residual problems remain, however.

One of the residual problems relates to the fact that the statistically representative value thus calculated is typically very small (because the probabilities for individual diseases are small). Although computers are quite capable of processing numbers of whatever size or range, humans find it easier to treat numbers that are referenced to a base value of the form 10N, wherein N is a non-negative integer. In other words, the statistically representative value (the index) is may reference a base value of 1, 10, 100, etc. Reference number 2-30 denotes such an optional presentation phase, which comprises scaling of the index to a more user-friendly scale.

At 2-32, the statistically representative value is plotted on a compressive scale. As used herein, a compressive function or scale is one that emphasizes small values in comparison with large values. In a typical but non-restrictive implementation a log function, such as log2 function is used to compress the scale. Zero values are replaced by marginal finite values, eg. 0.001, if the compressive function cannot process zero values.

Finally, at 2-34, the values are scaled in such a manner that an animal free from hereditary diseases obtains a simple base value (e.g., 100) and the animal with highest burden of hereditary diseases obtains a value of 20-80, preferably 40-60 and optimally about 55 on a scale of 0-100.

Another residual problem remaining after operation 2-28 is that it does not account for heterozygosity. Depending on the degree of heterozygosity, the index as calculated by the process shown in FIG. 2, should be adjusted up or down.

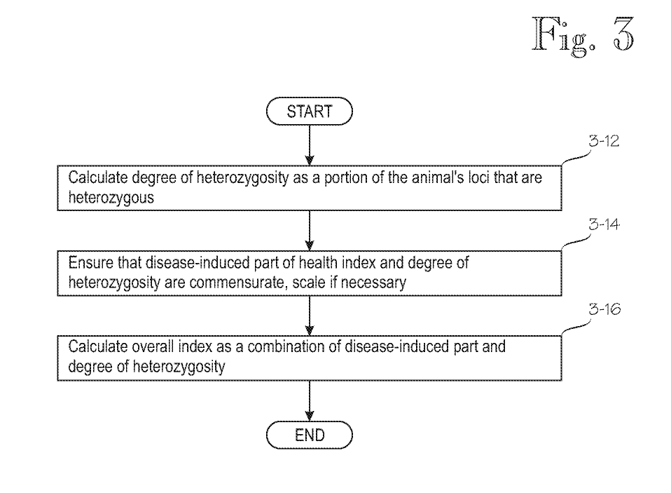

FIG. 3 is a flow chart that illustrates how degree of heterozygosity is taken into account in the calculation of overall GHI. At 3-12, a degree of heterozygosity is calculated as a portion of the animal's loci that are heterozygous. Operation 3-14 comprises ensuring that the disease-induced part of the GHI (as obtained in the process of FIG. 2) and the heterozygosity (as obtained at 3-12) are commensurate. If not, appropriate scaling is used. Finally, at 3-16 an overall GHI index is calculated as a combination of the disease-induced part and the degree of heterozygosity. Exemplary calculation rules have been given earlier in this document.

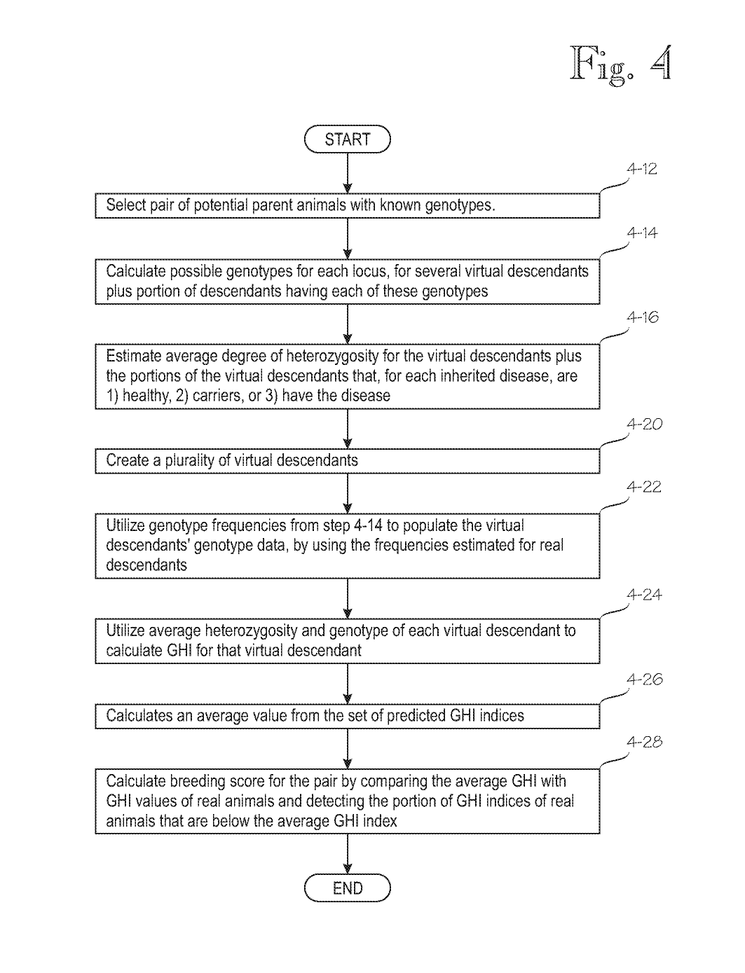

FIG. 4 is flow chart that illustrates prediction of the GHI for descendants of pair of male and female animals known by the data processing system.

At 4-12, potential parent animals (one male, one female) are selected. Genotypes of the potential parents should be known by the data processing system. Operation 4-14 comprises simulating descendants by creating “virtual descendants”. This can be accomplished by calculation of possible genotypes for each locus, for a plurality of virtual descendants. This kind of calculation is possible because the data processing system knows the genotypes of both potential parents for each locus. Operation 4-14 also comprises calculating the portion of descendants that have each of these geno-types.

At 4-16, the data processing system uses the results of operation 4-14 to estimate average degree of heterozygosity for the virtual descendants. Operation 4-16 also comprises estimating the portions of the virtual descendants that, for each inherited disease, are 1) healthy, 2) carriers, or 3) have the disease.

Operation 4-20 comprises a scoring process as follows. The data processing system creates a plurality of virtual descendants. The size of the plurality is a compromise between statistical representativeness and processing burden. The inventors have found out that a value of about 512 is adequate. At 4-22 the data processing system utilizes the genotype frequencies for each locus that were calculated at 4-14, to populates the virtual descendant's genotype data, by using the frequencies estimated for real descendants.

At 4-24, the data processing system utilizes the average heterozygosity and the genotype of each virtual descendant, and calculates the GHI for that virtual descendant (as was described in the general section and in connection with FIGS. 2 and 3). The set of GHI indices thus calculated described the distribution of the potential parent animals.

At 4-26 the data processing system calculates a statistically representative value from the set of predicted GHI indices, such as average, mean or the like. Operation 4-28 comprises comparing the statistically representative GHI with GHI values of real animals and detecting the portion of GHI indices of real animals that are below the statistically representative value of the set of predicted GHI indices. This portion, which is in the range of 0-1, is the breeding score for the pair of potential parents. The breeding score may be expressed as a percentage value.

Some implementations of the calculation of the breeding score utilize information of highly severe diseases. Such diseases may be maintained in a separate “black list”. If the data processing system detects any genotypes of the virtual descendants that would indicate such severe diseases, the pair of potential parents is rejected. For either animal of the potential pair, the other potential partner will not be listed as a candidate partner.

With regard to the act of creating virtual descendants by calculation of possible genotypes for each locus, for a plurality of virtual descendants, it should be observed that inheritance of a combination of alleles is not entirely random. This is because genes occupy nearby regions in the genotype, and in general, the farther apart from each other the genes are, the more random is the inheritance of two genes. This phenomenon is referred to as linkage disequilibrium. Some implementations of the simulation of descendants are based on the assumption that all genes are inherited randomly, but more ambitious implementations take increasing knowledge of coupling between genes into account when assigning probabilities to inheritance of genes.

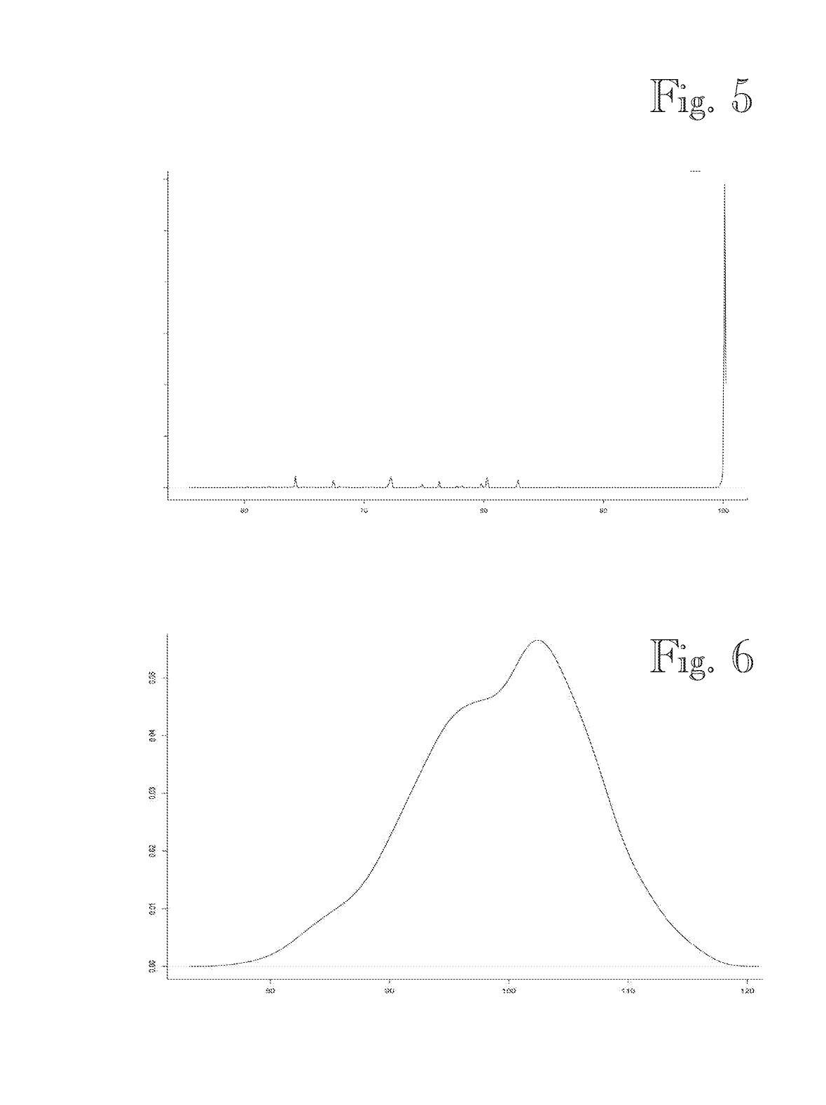

FIG. 5 shows a distribution of a disease-induced part of the GHI for a number of dogs which were known by a version of the inventive data processing system. In one experiment, this number was 1623. As described earlier, the scaling of the GHI is such that an animal free from hereditary diseases obtains a value of 100. As can be seen from FIG. 5, most dogs obtained a value of 100, which means that these dogs neither had any diseases nor acted as carriers. Another interesting observation was that the distribution was far from continuous. Instead, the burden of hereditary diseases appeared as clusters. Such clustering is presumably the result of strict breeding within races, whereby there is substantial similarity between genotypes of the dogs within a given race.

FIG. 6 shows the distribution of the degree of heterozygosity for the 1623 of dogs discussed in connection with FIG. 5. As can be seen, heterozygosity closely folow normal distribution without additional processing. The deviations at the peak is likely caused by the fact that the database of the data processing system has widely different numbers of dogs of various races, whereby races with a large number of dogs contribute to the distribution by local race-specific peaks. The degree of heterozygosity is assumed to follow normal distribution even more closely as the number of dogs known by the system increases. As was described earlier, scaling was carried out in such a manner that a majority of dogs obtained a value between 80-120.

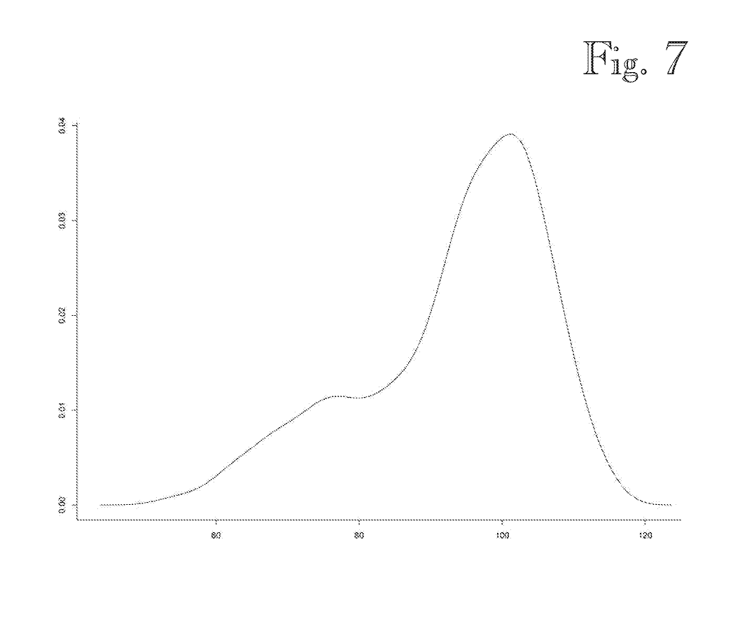

FIG. 7 shows a combined GHI as a combination of the disease-induced part and the degree of heterozygosity. As derived from the population of dogs known by the system, the combined GHI varies in the range of 50-115. The peak of the distribution is approximately at a value of 100. Dogs with a GHI higher than 100 are practically healthy, with larger than average heterozygosity. In contrast, dogs at the low end of the distribution are ones burdened with several severe diseases, regardless of heterozygosity.

Those skilled in the art will realize that the inventive principle may be modified in various ways without departing from the scope of the disclosed embodiments.

1-9. (canceled)

10. A method comprising:
estimating overall genomic health of a sexually reproducing organism or its virtual presentation, wherein said estimating comprises:
in a set-up phase:
storing information on a plurality of hereditary diseases potentially affecting a species of the sexually reproducing organism;
for each hereditary disease in the plurality of hereditary diseases:
determining a risk for that disease for a plurality of allele combinations in a specimen of the species;
determining a degree of severity in the species;
wherein the risk and severity are commensurate;
in a specimen-specific phase:
for each hereditary disease:
determining a risk for the specimen to have the hereditary disease from the from the specimen's genotype;
assigning a default risk which is between 0.2 and 0.8 of the range of values for the risk, if the hereditary disease exhibits Mendelian inheritance and if the specimen is a carrier of the disease;
multiplying the risk for the hereditary disease by an expansive function of the severity; and
calculating a statistically representative value of the multiplied risks.

11. The method of claim 10, further comprising:
calculating a degree of heterozygosity as a portion of the specimen's loci that are heterozygous, wherein the degree of heterozygosity is commensurate with the statistically representative value of the multiplied risks; and
calculating a combined genomic health index as a combination of the statistically representative value of the multiplied risks and the degree of heterozygosity.

12. The method of claim 10, further comprising:
applying a compressive scaling function on the calculated statistically representative value, replacing zero values with marginal finite values if the compressive scaling function cannot process zero values;
wherein the compressive scaling function is scaled in such a manner that a specimen free from hereditary diseases obtains a base value of 10^{N}, wherein N is an integer, and the specimen known to have highest statistically representative value of the multiplied risks obtains a value of k·10^{N}, wherein k=0.3−0.7.

13. The method of claim 11, wherein the sexually reproducing organism is a non-human organism, the method further comprising:
selecting a pair of potential parent specimens with known genotypes;
calculating possible genotypes for each locus for several virtual descendants, plus portion of descendants having each of the calculated genotypes;
estimating an average degree of heterozygosity for the virtual descendants plus the portions of the virtual descendants that, for each inherited disease, are healthy, carriers, or have the disease;
creating a plurality of virtual descendants;
utilizing genotype frequencies from the calculation of genotypes to populate genotype data of the virtual descendants, by using genotype frequencies estimated for real descendants;
applying the method according to claim 2 to the virtual descendants, to calculate a combined genomic health index for each virtual descendant from the average heterozygosity and the populated genotype data of the virtual descendant;
calculating a second statistically representative value from the calculated combined genomic health indices for the virtual descendants; and
calculating a breeding score for the pair of potential parent specimens, wherein the breeding score is at least partially based on a detected portion of combined genomic health indices of real specimens that are below the second statistically representative value calculated for the virtual descendants.

14. The method of claim 13, wherein the calculating possible genotypes plus portion of descendants having the calculated genotypes comprises adjusting probabilities to inherited genes based on closeness between genes.

15. The method of claim 10, wherein the sexually reproducing organism is an animal.

16. The method of claim 15, wherein the animal is a non-human animal.

17. The method of claim 11, wherein the sexually reproducing organism is an animal.

18. The method of claim 17, wherein the animal is a non-human animal.

19. The method of claim 12, wherein the sexually reproducing organism is an animal.

20. The method of claim 19, wherein the animal is a non-human animal.

21. The method of claim 13, wherein the sexually reproducing organism is an animal.

22. The method of claim 21, wherein the animal is a non-human animal.

23. The method of claim 14, wherein the sexually reproducing organism is an animal.

24. The method of claim 23, wherein the animal is a non-human animal.

25. A data processing system comprising:
a memory system for storing program code instructions and data;
a processing system including at least one processing unit, wherein the processing system executes at least a portion of the program code instructions and processes the data;
an interface for receiving data representative of a genotype of a each of a plurality of sexually reproducing organims;
wherein the memory system stores program code instructions that, when executed by the processing system, instruct the processing system to estimate an overall genomic health of a sexually reproducing organism or its virtual presentation, wherein said estimating comprises:
in a set-up phase:
storing information on a plurality of hereditary diseases potentially affecting a species of a sexually reproducing organism;
for each hereditary disease in the plurality of hereditary diseases:
determining a risk for that disease for a plurality of allele combinations in a specimen of the species;
determining a degree of severity in the species;
wherein the risk and severity are commensurate;
in a specimen-specific phase:
for each hereditary disease:
determining a risk for the specimen to have the hereditary disease from the from the specimen's genotype;
assigning a default risk which is between 0.2 and 0.8 of the range of values for the risk, if the hereditary disease exhibits Mendelian inheritance and if the specimen is a carrier of the disease;
multiplying the risk for the hereditary disease by an expansive function of the severity; and
calculating a statistically representative value of the multiplied risks.

26. The system of claim 25, wherein the estimating further comprises:
calculating a degree of heterozygosity as a portion of the specimen's loci that are heterozygous, wherein the degree of heterozygosity is commensurate with the statistically representative value of the multiplied risks; and
calculating a combined genomic health index as a combination of the statistically representative value of the multiplied risks and the degree of heterozygosity.

27. The system of claim 25, wherein the estimating further comprises:
applying a compressive scaling function on the calculated statistically representative value, replacing zero values with marginal finite values if the compressive scaling function cannot process zero values;
wherein the compressive scaling function is scaled in such a manner that a specimen free from hereditary diseases obtains a base value of 10^{N}, wherein N is an integer, and the specimen known to have highest statistically representative value of the multiplied risks obtains a value of k·10^{N}, wherein k=0.3−0.7.

28. The system of claim 27, wherein the sexually reproducing organism is a non-human organism, and the estimating further comprises:
selecting a pair of potential parent specimens with known genotypes;
calculating possible genotypes for each locus for several virtual descendants, plus portion of descendants having each of the calculated genotypes;
estimating an average degree of heterozygosity for the virtual descendants plus the portions of the virtual descendants that, for each inherited disease, are healthy, carriers, or have the disease;
creating a plurality of virtual descendants;
utilizing genotype frequencies from the calculation of genotypes to populate genotype data of the virtual descendants, by using genotype frequencies estimated for real descendants;
applying the method according to claim 2 to the virtual descendants, to calculate a combined genomic health index for each virtual descendant from the average heterozygosity and the populated genotype data of the virtual descendant;
calculating a second statistically representative value from the calculated combined genomic health indices for the virtual descendants; and
calculating a breeding score for the pair of potential parent specimens, wherein the breeding score is at least partially based on a detected portion of combined genomic health indices of real specimens that are below the second statistically representative value calculated for the virtual descendants.

29. The system of claim 28, wherein the calculating possible genotypes plus portion of descendants having the calculated genotypes comprises adjusting probabilities to inherited genes based on closeness between genes.

30. The system of claim 25, wherein the sexually reproducing organism is an animal.

31. The system of claim 31, wherein the animal is a non-human animal.

32. A tangible non-transitory program carrier comprising program code instructions for a data processing system, wherein the data processing system comprises: a memory system for storing program code instructions and data; a processing system including at least one processing unit, wherein the processing system executes at least a portion of the program code instructions and processes the data; and an interface for receiving data representative of a genotype of a each of a plurality of sexually reproducing organims;
wherein the tangible non-transitory program carrier comprises program code instructions that, when executed by the processing system, instruct the processing system to carry out the method comprising:
estimating overall genomic health of a sexually reproducing organism or its virtual presentation, wherein said estimating comprises:
in a set-up phase:
storing information on a plurality of hereditary diseases potentially affecting a species of the sexually reproducing organism;
for each hereditary disease in the plurality of hereditary diseases:
determining a risk for that disease for a plurality of allele combinations in a specimen of the species;
determining a degree of severity in the species;
wherein the risk and severity are commensurate;
in a specimen-specific phase:
for each hereditary disease:
determining a risk for the specimen to have the hereditary disease from the from the specimen's genotype;
assigning a default risk which is between 0.2 and 0.8 of the range of values for the risk, if the hereditary disease exhibits Mendelian inheritance and if the specimen is a carrier of the disease;
multiplying the risk for the hereditary disease by an expansive function of the severity; and
calculating a statistically representative value of the multiplied risks.
